(19) United States
(12) Patent Application Publication
(10) Pub. No.: US 2020/0207975 A1
(43) Pub. Date: Jul. 2, 2020

(54) RESIN COMPOSITION AND MOLDED ARTICLE THEREOF

(71) Applicant: ASAHI KASEI KABUSHIKI KAISHA, Tokyo (JP)

(72) Inventors: Shunichiro I, Tokyo (JP); Yasukazu Shikano, Tokyo (JP)

(73) Assignee: ASAHI KASEI KABUSHIKI KAISHA, Tokyo (JP)

(21) Appl. No.: 16/722,659

(22) Filed: Dec. 20, 2019

(30) Foreign Application Priority Data
Dec. 26, 2018 (JP) 2018-243360

(51) Int. Cl. C08L 59/00; C08K 5/098; C08K 3/22; C08K 5/00; C08K 5/13; C08L 77/00

(52) U.S. Cl. CPC C08L 59/00; C08K 5/098; C08K 3/22; C08K 5/005; C08K 2201/005; C08L 77/00; C08L 2201/08; C08K 2003/2296; C08K 5/13

(57) ABSTRACT

Provided is a resin composition that is excellent in balance between tenacity and rigidity, suppresses variation in physical properties, and is further excellent in moldability. The disclosure provides a resin composition at least comprising 100 parts by mass of polyacetal resin (A), 0.01 to 1 part by mass of fatty acid metal salt (B), and 0.1 to 3 parts by mass of zinc oxide (C), wherein a total content of the polyacetal resin (A), the fatty acid metal salt (B), and the zinc oxide (C) is 98.0% by mass or more.

### TECHNICAL FIELD

The disclosure relates to a polyacetal resin composition and a molded article comprising the same.

### BACKGROUND

Polyacetal resin is widely used as an engineering resin having well-balanced mechanical properties and excellent friction and wear behavior in various mechanical members as well as OA equipment, etc. For automobile purposes, the polyacetal resin is required to have improved heat resistance or acid resistance. The improvement in the acid resistance of the polyacetal resin has previously described in some disclosures. For example, a method of adding zinc oxide and polyalkylene glycol to polyacetal resin in order to improve tenacity and fuel resistance (see, for example, JP2001011284A (PTL 1) and WO2016/104255 (PTL 2)), and a method of adding zinc oxide and polyolefin to polyacetal resin in order to improve wear resistance (see, for example, JP2011208114A (PTL 3)) have been disclosed.

### CITATION LIST

### Patent Literature

PTL 1: JP2001011284A

PTL 2: WO2016/104255

PTL 3: JP2011208114A

### SUMMARY

However, problems of polyacetal resin compositions provided with fuel resistance by zinc oxide are reduction in balance between tenacity and rigidity and increase in variation in physical properties.

In recent years, metal members have been being rapidly replaced with resins in fields including automobiles as well as electric or electronic equipment, etc. for the purpose of weight reduction and cost reduction. These resin parts require materials that suppress variation in physical properties and have well-balanced tenacity and rigidity.

Accordingly, an object of the disclosure is to provide a resin composition that is excellent in balance between tenacity and rigidity, suppresses variation in physical properties, and is further excellent in moldability.

The inventors of the disclosure have conducted diligent studies to solve the problems of the conventional techniques mentioned above, and consequently completed the disclosure by finding that in a resin composition comprising polyacetal resin, and fatty acid metal salt and zinc oxide added thereto, combined use of specific fatty acid metal salt and specific zinc oxide can solve the conventional problems.

Specifically, the present embodiment is as follows.
[1] A resin composition at least comprising 100 parts by mass of polyacetal resin (A), 0.01 to 1 part by mass of fatty acid metal salt (B), and 0.1 to 3 parts by mass of zinc oxide (C), wherein a total content of the polyacetal resin (A), the fatty acid metal salt (B), and the zinc oxide (C) is 98.0% by mass or more.
[2] The resin composition according to [1], wherein a content ratio of the fatty acid metal salt (B) to the zinc oxide (C) is 0.053 to 1.000.
[3] The resin composition according to [2], wherein a content ratio of the fatty acid metal salt (B) to the zinc oxide (C) is 0.250 to 0.667.
[4] The resin composition according to any of [1] to [3], wherein the fatty acid metal salt (B) is at least one member selected from the group consisting of calcium stearate and zinc stearate.
[5] The resin composition according to any of [1] to [4], wherein the zinc oxide (C) has an average primary particle size of 0.3 to 0.8 μm.
[6] The resin composition according to any of [1] to [5], wherein a total amount of the fatty acid metal salt (B) and the zinc oxide (C) is 0.6 to 1.4 parts by mass per 100 parts by mass of polyacetal resin (A).
[7] The resin composition according to any of [1] to [6], further comprising 0.1 to 0.4 parts by mass of a hindered phenol-based antioxidant per 100 parts by mass of the polyacetal resin (A).
[8] The resin composition according to [7], further comprising 0.01 to 0.03 parts by mass of polyamide resin per 100 parts by mass of the polyacetal resin (A).
[9] The resin composition according to [8], consisting of only the polyacetal resin (A), the fatty acid metal salt (B), the zinc oxide (C), the hindered phenol-based antioxidant, and the polyamide resin.
[10] A molded article comprising a resin composition according to any of [1] to [9].

The disclosure can provide a resin composition that is excellent in balance between tenacity and rigidity, suppresses variation in physical properties, and is further excellent in moldability.

### DETAILED DESCRIPTION

Hereinafter, a mode for carrying out the disclosure (hereinafter, also referred to as the “present embodiment”) will be described in detail. The following present embodiment will be given for illustrating the disclosure and does not limit the contents of the disclosure to those given below. Various changes or modifications can be made in the disclosure without departing from the spirit of the disclosure.

### Resin Composition

The resin composition of the present embodiment is a resin composition comprising at least a polyacetal resin (A), a fatty acid metal salt (B), and a zinc oxide (C).

In the resin composition of the present embodiment, the total content of the polyacetal resin (A), the fatty acid metal salt (B), and the zinc oxide (C) in the resin composition (100% by mass) is 98.0% by mass or more. The total content is preferably 98.5% by mass or more, more preferably 99.0% by mass or more. The total content of the components (A), (B), and (C) that is equal to or more than the specific range described above can provide a polyacetal resin composition that is excellent in balance between tenacity and rigidity and is further excellent in moldability.

As mentioned later, a stabilizer and an additive may be appropriately added to the resin composition of the present embodiment. Since the polyacetal resin (A) has no functional group in the molecular structure, larger amounts of the stabilizer and the additive added easily cause reduction in compatibility or poor dispersion in the polyacetal resin (A) and may influence various physical properties. Particularly, if the content of a component other than the components (A), (B), and (C) in the resin composition (100% by mass) is more than 2.0% by mass, i.e., if the total content of the components (A), (B), and (C) is less than 98.0% by mass, there is apprehension about deterioration of the surface appearance of a molded article, mold deposits during continuous injection molding, etc. However, the total content of the components (A), (B), and (C) is adjusted to 98.0% by mass or more, and the amount of the fatty acid metal salt (B) added and the amount of the zinc oxide (C) added are adjusted to specific ranges as mentioned later. This suppresses the apprehension described above and can provide excellent balance between tenacity and rigidity and suppress variation in physical properties.

<Polyacetal Resin (A)>

Examples of the polyacetal resin (A) according to the present embodiment include polyacetal homopolymers and polyacetal copolymers. Polyacetal resin known in the art may be used.

The polyacetal homopolymer is obtained by homopolymerizing a formaldehyde monomer or a cyclic oligomer of formaldehyde such as a trimer (trioxane) or a tetramer (tetraoxane) thereof. Thus, the polyacetal homopolymer consists substantially of an oxymethylene unit.

The polyacetal copolymer is obtained by copolymerizing a formaldehyde monomer or a cyclic oligomer of formaldehyde such as a trimer (trioxane) or a tetramer (tetraoxane) thereof with cyclic ether or cyclic formal, such as ethylene oxide, propylene oxide, epichlorohydrin, or cyclic formal of glycol or diglycol such as 1,3-dioxolane or 1,4-butanediol formal. Alternatively, the polyacetal copolymer used may be a polyacetal copolymer having a branch, obtained by copolymerizing a formaldehyde monomer and/or a cyclic oligomer of formaldehyde with monofunctional glycidyl ether; or a polyacetal copolymer having a cross-linked structure, obtained by copolymerizing a formaldehyde monomer and/or a cyclic oligomer of formaldehyde with polyfunctional glycidyl ether.

The polyacetal resin (A) may be a polyacetal homopolymer having a block component obtained by polymerizing a formaldehyde monomer or a cyclic oligomer of formaldehyde in the presence of a compound having a functional group such as a hydroxy group at both ends or one end, for example, polyalkylene glycol.

Likewise, the polyacetal resin (A) may be a polyacetal copolymer having a block component obtained by copolymerizing a formaldehyde monomer or a cyclic oligomer of formaldehyde such as a trimer (trioxane) or a tetramer (tetraoxane) thereof with cyclic ether or cyclic formal in the presence of a compound also having a functional group such as a hydroxy group at both ends or one end, for example, hydrogenated polybutadiene glycol.

As mentioned above, any of polyacetal homopolymers and polyacetal copolymers may be used as the polyacetal resin (A) according to the present embodiment.

These polyacetal resins (A) may be used alone or may be used in combination of two or more thereof. In this case, the polyacetal resin (A) preferably contains 50% by mass or more, more preferably 80% by mass or more, of a polyacetal copolymer. Most preferably, substantially almost the whole (95% by mass or more) polyacetal resin (A) is a polyacetal copolymer.

In this context, the percentage is based on 100% by mass in total of the polyacetal resin (A).

Hereinafter, a method for obtaining the polyacetal copolymer will be described in detail.

In the case of obtaining the polyacetal copolymer using trioxane, the comonomer such as 1,3-dioxolane is generally used at 0.1 to 60 mol %, preferably 0.1 to 20 mol %, more preferably 0.13 to 10 mol %, per 100 mol % of the trioxane. The polymerization catalyst for use in polymerization for the polyacetal copolymer is preferably a cationic active catalyst such as Lewis acid, or protic acid or ester or anhydride thereof. Examples of the Lewis acid include boric acid, and halides of tin, titanium, phosphorus, arsenic and antimony. More specific examples thereof include boron trifluoride, tin tetrachloride, titanium tetrachloride, phosphorus pentafluoride, phosphorus pentachloride, antimony pentafluoride and complex compounds or salts thereof. Specific examples of the protic acid or the ester or the anhydride thereof include perchloric acid, trifluoromethanesulfonic acid, perchloric acid-tertiary butyl ester, acetyl perchlorate and trimethyloxonium hexafluorophosphate. Among them, boron trifluoride, boron trifluoride hydride, and a coordinate complex compound of an organic compound containing an oxygen atom or a sulfur atom and boron trifluoride are preferred. Specific examples thereof include boron trifluoride diethyl ether and boron trifluoride di-n-butyl ether.

In addition to the polymerization catalyst, a polymerization chain agent (chain transfer agent) such as methylal may be appropriately used for obtaining the polyacetal copolymer. The methylal used is preferably methylal having a water content of 100 ppm by mass or less and a methanol content of 1% by mass or less, more preferably a water content of 50 ppm by mass or less and a methanol content of 0.7% by mass or less.

The polyacetal copolymer can be obtained through polymerization by a conventional method known in the art, for example, any of methods described in U.S. Pat. Nos. 3,027,352 and 3,803,094, German Patent Nos. 1161421, 1495228, 1720358, and 3018898, JPS5898322A and JPH770267A. The polyacetal copolymer thus obtained by the polymerization may contain a thermally unstable terminal site (—(OCH₂)n-OH group; hereinafter, referred to as an “unstable terminal site”).

Therefore, it is preferred to carry out the decomposition and removal treatment (terminal stabilization) of this unstable terminal site using a terminal stabilizer. Examples of the terminal stabilizer include, but are not particularly limited to, basic substances including: aliphatic amine compounds such as ammonia, triethylamine, and tributylamine; inorganic weak acid salts of alkali metals or alkaline earth metals, such as hydroxides, carbonates, phosphates, silicates and borates of alkali metals or alkaline earth metals (e.g., sodium, potassium, magnesium, calcium, and barium); and organic acid salts of alkali metals or alkaline earth metals, such as formates, acetates, stearates, palmitates, propionates and oxalates of alkali metals or alkaline earth metals. Among them, aliphatic amine compounds are preferred, and triethylamine is more preferred.

Examples of the method for decomposing and removing the unstable terminal site include, but are not particularly limited to, a method of heat-treating the polyacetal copolymer in a molten state at a temperature equal to or higher than the melting point of the polyacetal copolymer and equal to or lower than 260° C. in the presence of a terminal stabilizer such as triethylamine. Examples of the method for heat treatment include single screw or twin screw extruders equipped with a vent decompression apparatus. A twin screw extruder is preferred.

The melt flow rate (conforming to ISO1133, 190° C., 2.16 kg load) of the polyacetal resin (A) used in the present embodiment is preferably in the range of 1 to 50 g/10 min, more preferably in the range of 1 to 40/10 min, most preferably in the range of 2 to 15 g/10 min, from the viewpoint of productivity. Specific examples of the method for obtaining the polyacetal resin (A) having MFR in the range described above include the adjustment of the amount of a chain transfer agent (typified by methylal or the like) added in the production of the polyacetal resin.

In the present embodiment, the content of the polyacetal resin (A) in the resin composition (100% by mass) can be 95% by mass or more and is preferably 97% by mass or more, more preferably 98% by mass or more.

<Fatty acid metal salt (B)>The fatty acid metal salt (B) according to the present embodiment is fatty acid metal salt obtained from saturated or unsaturated fatty acid having 10 to 35 carbon atoms or fatty acid substituted by a hydroxy group, and hydroxide, oxide or chloride of an alkali metal or an alkaline earth metal.

The amount of the fatty acid metal salt added is 0.01 to 1 part by mass, preferably 0.25 to 0.7 parts by mass, more preferably 0.3 to 0.5 parts by mass, most preferably 0.3 to 0.4 parts by mass, per 100 parts by mass of the polyacetal resin.

The starting material fatty acid for the fatty acid metal salt is capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, lacceric acid, undecylenic acid, oleic acid, elaidic acid, cetoleic acid, erucic acid, brassidic acid, sorbic acid, linoleic acid, linolenic acid, arachidonic acid, propiolic acid, stearolic acid, 12-hydroxydodecanoic acid, 3-hydroxydecanoic acid, 16-hydroxyhexadecanoic acid, 10-hydroxyhexadecanoic acid, 12-hydroxyoctadecanoic acid, 10-hydroxy-8-octadecanoic acid, dl-erythro-9,10-dihydroxyoctadecanoic acid, or the like. The starting material metal compound is hydroxide or chloride of an alkali metal or an alkaline earth metal (sodium, lithium, potassium, calcium, magnesium, barium, zinc, aluminum or strontium).

Among them, preferably, the starting material fatty acid for the fatty acid metal salt is myristic acid, palmitic acid, or stearic acid, and the starting material metal compound is hydroxide, oxide, or chloride of calcium. Specific examples of the fatty acid metal salt include calcium myristate, calcium palmitate, calcium stearate, calcium (myristate-palmitate), calcium (myristate-stearate), and calcium (palmitate-stearate). Among them, calcium palmitate and calcium stearate are preferred.

Also preferably, the starting material fatty acid for the fatty acid metal salt is myristic acid, palmitic acid, or stearic acid, and the starting material metal compound is hydroxide, oxide, or chloride of zinc.

Specific examples of the fatty acid metal salt include zinc myristate, zinc palmitate, zinc stearate, zinc (myristate-palmitate), zinc (myristate-stearate), and zinc (palmitate-stearate). Among them, zinc palmitate and zinc stearate are preferred.

In the present embodiment, two or more fatty acid metal salts, for example, calcium stearate and calcium palmitate, may be added at the same time, or a metal salt of fatty acids having different numbers of carbon atoms, for example, calcium (palmitate-stearate), may be present. Alternatively, metal salts of different metals, for example, calcium stearate and zinc stearate, may coexist.

The fatty acid metal salts mentioned above may be used alone or may be used in combination of two or more thereof.

<Zinc Oxide (C)>The zinc oxide (C) according to the present embodiment is not limited by its production method and is industrially a white powder produced by a dry process or a wet process.

The amount of the zinc oxide (C) added is 0.1 to 3 parts by mass, preferably 0.2 to 0.9 parts by mass, more preferably 0.5 to 0.8 parts by mass, per 100 parts by mass of the polyacetal resin. When the content of the zinc oxide (C) is 0.1 to 3 parts by mass per 100 parts by mass of the polyacetal resin (A), excellent tenacity is obtained in the polyacetal resin composition of the present embodiment.

The zinc oxide (C) used is zinc oxide having an average primary particle size in the range of 0.07 to 1.0 μm, preferably 0.3 to 0.8 μm, more preferably 0.4 to 0.7 μm. Use of the zinc oxide (C) having an average primary particle size in the range described above produces excellent balance between tenacity and rigidity in the polyacetal resin composition of the present embodiment. When the average primary particle size of the zinc oxide (C) falls within the specific numerical range mentioned above, the excellent balance between tenacity and rigidity is obtained, probably because dispersibility in the polyacetal resin composition is improved (however, the effect is not limited thereto).

The average primary particle size of the zinc oxide (C) can be measured using a laser diffraction particle size distribution measuring apparatus (e.g., manufactured by Shimadzu Corporation, model: SALD-2300).

The polyacetal resin composition of the present embodiment is constituted by the components (A) to (C) described above as basic components.

In the present embodiment, the content ratio of the fatty acid metal salt (B) to the zinc oxide (C) is selected from the range of 0.053 to 1.000, preferably 0.250 to 1.000, more preferably 0.429 to 0.818, most preferably 0.429 to 0.667, from the viewpoint of the balance between tenacity and rigidity and the suppression of variation in physical properties.

The total amount of the fatty acid metal salt (B) and the zinc oxide (C) is preferably 0.6 to 1.4 parts by mass, more preferably 0.6 to 1.3 parts by mass, most preferably 0.8 to 1.1 parts by mass, per 100 parts by mass of the polyacetal resin (A) from the viewpoint of the quality of the resulting resin composition.

<Stabilizer>

The polyacetal resin composition of the present embodiment can comprise any of various conventional stabilizers for use in polyacetal resin compositions without impairing the object of the disclosure. Specific examples of the stabilizer include antioxidants and scavengers of formaldehyde or formic acid described below. These stabilizes may be used alone or may be used in combination of two or more thereof.

The antioxidant is preferably a hindered phenol-based antioxidant from the viewpoint of improvement in the thermal stability of the polyacetal resin composition.

Specific examples of the hindered phenol-based antioxidant include n-octadecyl-3-(3′,5′-di-t-butyl-4′-hydroxyphenyl)-propionate, n-octadecyl-3-(3′-methyl-5′-t-butyl-4′-hydroxyphenyl)-propionate, n-tetradecyl-3-(3′,5′-di-t-butyl-4′-hydroxyphenyl)-propionate, 1,6-hexanediol-bis-(3-(3,5-di-t-butyl-4-hydroxyphenyl)-propionate), 1,4-butanediol-bis-(3-(3,5-di-t-butyl-4-hydroxyphenyl)-propionate), and triethylene glycol-bis-(3-(3-t-butyl-5-methyl-4-hydroxyphenyl)-propionate).

Other examples of the hindered phenol-based antioxidant include tetrakis-(methylene-3-(3′,5′-di-t-butyl-4′-hydroxyphenyl)propionatemethane, 3,9-bis(2-(3-(3-t-butyl-4-hydroxy-5-methylphenyl)propionyloxy)-1,1-dimethy lethyl)-2,4,8,10-tetraoxaspiro(5,5)undecane, N,N′-bis-3-(3′,5′-di-t-butyl-4-hydroxyphenol)propionylhexamethylenediamine

N,N′-tetramethylenebis-3-(3′-methyl-5′-t-butyl-4-hydroxyphenol)propionyldia mine, N,N′-bis-(3-(3,5-di-t-butyl-4-hydroxyphenol)propionyl)hydrazine, N-salicyloyl-N′-salicylidenehydrazine, 3-(N-salicyloyl)amino-1,2,4-triazole, and N,N′-bis(2-(3-(3,5-di-butyl-4-hydroxyphenyl)propionyloxy)ethyl)oxyamide.

Among the hindered phenol-based antioxidants mentioned above, triethylene glycol-bis-(3-(3-t-butyl-5-methyl-4-hydroxyphenyl)-propionate) and tetrakis-(methylene-3 -(3′, 5′-di-t-butyl-4′-hydroxyphenyl)propionate)methane are preferred from the viewpoint of improvement in the thermal stability of the polyacetal resin composition.

Specific examples of the scavenger of formaldehyde or formic acid include compounds containing formaldehyde-reactive nitrogen and polymers thereof, and hydroxides, inorganic acid salts, and carboxylic acid salts of alkali metals or alkaline earth metals.

Specific examples of the compound containing formaldehyde-reactive nitrogen and the polymer thereof include dicyandiamide, melamine, co-condensates of melamine and formaldehyde, polyamide resin such as nylon 4-6, nylon 6, nylon 6-6, nylon 6-10, nylon 6-12, nylon 12, nylon 6/6-6, nylon 6/6-6/6-10, and nylon 6/6-12, poly-β-alanine, and polyacrylamide. Among them, a co-condensate of melamine and formaldehyde, polyamide resin, poly-β-alanine and polyacrylamide are preferred. Polyamide resin and poly-β-alanine are more preferred from the viewpoint of improvement in the thermal stability of the polyacetal resin composition.

Specific examples of the hydroxide, the inorganic acid salt, and the carboxylic acid salt of an alkali metal or an alkaline earth metal include hydroxide of sodium, potassium, magnesium, calcium or barium, and carbonate, phosphate, citrate, borate and carboxylate of the metal. Calcium salt is preferred from the viewpoint of improvement in the thermal stability of the polyacetal resin composition. Specific examples of the calcium salt include calcium hydroxide, calcium carbonate, calcium phosphate, calcium citrate, calcium borate, and fatty acid calcium salt (calcium stearate, calcium myristate, etc.). These fatty acids may be substituted by a hydroxyl group. Among them, fatty acid calcium salt (calcium stearate, calcium myristate, etc.) is more preferred from the viewpoint of improvement in the thermal stability of the polyacetal resin composition.

The combination of the various stabilizers mentioned above is preferably a combination of a hindered phenol-based antioxidant typified by triethylene glycol-bis-(3-(3-t-butyl-5-methyl-4-hydroxyphenyl)-propionate) or tetrakis-(methylene-3-(3′,5′-di-t-butyl-4′-hydroxyphenyl)propionate)methane, a polymer containing formaldehyde-reactive nitrogen, typified by polyamide resin or poly-β-alanine, and fatty acid salt of an alkaline earth metal typified by fatty acid calcium salt, from the viewpoint of improvement in the thermal stability of the polyacetal resin composition.

The content of each stabilizer mentioned above is preferably in the ranges of 0.1 parts by mass or more and 2 parts by mass or less of the antioxidant, for example, the hindered phenol-based antioxidant, 0.01 parts by mass or more and 2 parts by mass or less of the scavenger of formaldehyde or formic acid, for example, the polymer containing formaldehyde-reactive nitrogen, and 0.1 parts by mass or more and 1 part by mass or less of the fatty acid salt of an alkaline earth metal, per 100 parts by mass of the polyacetal resin (A).

The polyacetal resin composition of the present embodiment particularly preferably contains 0.1 parts by mass or more and 0.4 parts by mass or less of the hindered phenol-based antioxidant as the antioxidant per 100 parts by mass of the polyacetal resin (A).

When the polyacetal resin composition of the present embodiment contains the stabilizer, this polyacetal resin composition preferably contains 0.1 parts by mass or more and 0.4 parts by mass or less of the hindered phenol-based antioxidant and 0.01 parts by mass or more and 0.03 parts by mass or less of the polyamide resin per 100 parts by mass of the polyacetal resin (A), and particularly preferably consists of only the components (A), (B), and (C), the hindered phenol-based antioxidant, and the polyamide resin (preferably, polyamide 6-6).

<Additive>

The polyacetal resin composition of the present embodiment can contain any of various conventional additives for use in polyacetal resin compositions according to the desired properties without impairing the object of the disclosure. Specific examples of the additive include inorganic fillers, crystal nucleating agents, thermoplastic resins, thermoplastic elastomers, and pigments described below. These additives may be used alone or may be used in combination of two or more thereof.

Specifically, the inorganic filler used is, for example, a fibrous, powdery or particulate, sheet-like or hollow filler.

Specific examples of the fibrous filler include inorganic fibers including glass fiber, carbon fiber, silicone fiber, silica-alumina fiber, zirconia fiber, boron nitride fiber, silicon nitride fiber, boron fiber, potassium titanate fiber, and metal fibers such as stainless, aluminum, titanium, copper, and brass. Other examples of the fibrous filler include: whiskers, such as potassium titanate whisker and zinc oxide whisker, having a short fiber length; and high-melting organic fibrous substances such as aromatic polyamide resin, fluorine resin, and acrylic resin.

Specific examples of the powder or particulate filler include citrate such as silica, quartz powders, glass beads, glass powders, calcium silicate, aluminum silicate, kaolin, clay, diatomaceous earth, and wollastonite; metal oxides such as iron oxide, titanium oxide, and alumina; metal sulfates such as calcium sulfate and barium sulfate; carbonates such as magnesium carbonate and dolomite; and others such as silicon carbide, silicon nitride, boron nitride, and various metal powders.

Specific examples of the sheet-like filler include mica, glass flake, and various metal foils.

Specific examples of the hollow filler include glass balloon, silica balloon, Shirasu balloon, and metal balloon.

These inorganic fillers may be used alone or may be used in combination of two or more thereof.

Any of surface-treated fillers and surface-untreated fillers may be used as these inorganic fillers. A surface-treated filler may be preferred from the viewpoint of the surface smoothness of a molded article comprising the polyacetal resin composition and mechanical properties.

A conventional surface treatment agent known in the art may be used. Specific examples thereof include various coupling agents such as silane-based, titanate-based, aluminum-based, and zirconium-based coupling agents. Specific examples of the coupling agent include N-(2-aminoethyl)-3-aminopropyltriethoxysilane, 3-glycidoxypropyltrimethoxysilane, isopropyl trisstearoyl titanate, diisopropoxyammonium ethyl acetate, and n-butyl zirconate.

The content of the inorganic filler is preferably 0.1 parts by mass or more and 2 parts by mass or less, more preferably 0.5 parts by mass or more and 1 part by mass or less, per 100 parts by mass of the polyacetal resin (A).

Specific examples of the crystal nucleating agent include boron nitride. The content of the crystal nucleating agent is preferably 0.001 parts by mass or more and 2 parts by mass or less, more preferably 0.003 parts by mass or more and 1 part by mass or less, further preferably 0.005 parts by mass or more and 0.5 parts by mass or less, per 100 parts by mass of the polyacetal resin (A).

Specific examples of the thermoplastic resin include olefin resin other than those listed as the component (C). More specific examples thereof include copolymers containing an olefin compound represented by the general formula (3) in the range of less than 40 mol % with respect to all the monomer units, styrene resin, and polycarbonate resin. Other examples thereof include modified products thereof. The content of the thermoplastic resin is preferably 0.1 parts by mass or more and 2 parts by mass or less, more preferably 0.3 parts by mass or more and 1 part by mass or less, per 100 parts by mass of the polyacetal resin (A).

Specific examples of the thermoplastic elastomer include styrene elastomers, polybutadiene, polyisoprene, ethylene-propylene rubber, acrylic rubber and chlorinated polyethylene. The content of the thermoplastic elastomer is preferably 0.1 parts by mass or more and 2 parts by mass or less, more preferably 0.3 parts by mass or more and 1 part by mass or less, per 100 parts by mass of the polyacetal resin (A).

Specific examples of the pigment include inorganic pigments, organic pigments, metallic pigments, and fluorescent pigments. The inorganic pigment refers to one generally used for coloring resins. Specific examples thereof include zinc sulfide, titanium oxide, barium sulfate, titanium yellow, cobalt blue, calcination pigments, carbonate, phosphate, acetate, carbon black, acetylene black, and lampblack. Examples of the organic pigment include condensed azo-based, ynone-based, monoazo-based, diazo-based, polyazo-based, anthraquinone-based, heterocyclic, perinone-based, quinacridon-based, thioindigo-based, perylene-based, dioxazine-based, and phthalocyanine-based pigments. The amount of the pigment can be selected according to the desired color tone and is preferably in the range of 0.05 parts by mass or more and 2 parts by mass or less per 100 parts by mass of the polyacetal resin (A).

### Method for Producing Polyacetal Resin Composition

The polyacetal resin composition of the present embodiment can be produced by melt-kneading the polyacetal resin (A), the fatty acid metal salt

(B), and the zinc oxide (C) mentioned above, and optionally, other components.

A general kneading machine practically used can be applied to an apparatus for producing the polyacetal resin composition of the present embodiment. Specific examples of the kneading machine include single screw or multi-screw extruders, rolls, and Banbury mixers. Among them, a single screw extruder and a twin screw extruder are preferred.

Specific examples of the melt kneading method include a method which involves continuously feeding a blend of all the components from a feeder at the top of an extruder (hereinafter, referred to as a top feeder), and melt-kneading the blend, and a method which involves continuously feeding a blend of the components except for the zinc oxide (C) from an extruder top feeder, melt-kneading the blend, continuously feeding the zinc oxide (C) from a feeder disposed at the side of the extruder (hereinafter, referred to as a side feeder), and further melt-kneading the mixture, any of which can be used without problems.

### Molded Article

The molded article of the present embodiment comprises the polyacetal resin composition mentioned above. For this purpose, the molded article of the present embodiment can be obtained by molding the polyacetal resin composition mentioned above. The method for molding the polyacetal resin composition is not particularly limited, and a molding method known in the art can be applied thereto. Specific examples thereof include molding methods such as extrusion molding, injection molding, vacuum molding, blow molding, injection compression molding, decoration molding, dual injection molding, gas-assisted injection molding, expansion injection molding, low-pressure molding, ultrathin injection molding (ultrahigh-speed injection molding), and in-mold composite molding (insert molding and outsert molding).

### Purpose of Molded Article

Examples of the purpose of the molded article of the present embodiment include: mechanical members typified by cams, sliders, levers, arms, clutches, felt clutches, idler gears, pulleys, rollers, roller bearings, key systems, keytops, shutters, reels, shafts, joints, axes, bearings and guides, etc.; members for office automation equipment typified by resin parts for outsert molding, resin parts for insert molding, chassis, tray, lateral plates, printers, and copiers; members for camera or video equipment typified by VTR (video tape recorder), video movies, digital video cameras, cameras, and digital cameras; cassette players, DAT, LD (laser disk), MD (mini disk), CD (compact disk) [including CD-ROM (read only memory), CD-R (recordable), and CD-RW (rewritable)], DVD (digital video disk) [including DVD-ROM, DVD-R, DVD+R, DVD-RW, DVD+RW, DVD-R DL, DVD+R DL, DVD-RAM (random access memory), and DVD-audio], Blu-ray® (Blu-ray is a registered trademark in Japan, other countries, or both) discs, HD-DVD, and other optical disc drives; members for music, video or information equipment typified by MFD, MO, navigation systems, and mobile personal computers, and members for communication equipment typified by mobile phones and facsimiles; members for electric equipment; members for electronic equipment; and lamp materials for internal members of hard disk drives. Furthermore, the molded article of the present embodiment is also suitably used as an automobile member in members around fuel typified by gasoline tanks, fuel pump modules, valves, gasoline tank flanges, etc.; members around doors typified by door locks, door handles, window regulators, speaker grills, etc.; peripheral members of seatbelts typified by slip rings for seatbelts, and press buttons; members such as combination switch members, switches, and clips; pen points of mechanical pencils, and mechanical members for taking in and out leads of mechanical pencils; sink, drainage and plug open and close mechanical members; opening and closing part lock mechanisms and commodity discharging mechanical members for vending machines; code stoppers, adjusters, and buttons for clothing; nozzles for water sprinkling and water sprinkling hose connection joints; construction materials which are stair railings and floor material supports; industrial members typified by disposable cameras, toys, fasteners, chains, conveyors, buckles, sport goods, vending machines, furniture, musical instruments, and housing equipment; and the like.

### EXAMPLES

Hereinafter, the present embodiment will be specifically described with reference to Examples and Comparative Examples. However, the present embodiment is not limited by Examples and Comparative Examples mentioned later without departing from the spirit of the present embodiment. Various measurement methods for polyacetal resin compositions and molded articles of Examples and Comparative Examples, and components of starting materials for the polyacetal resin compositions and the molded articles used in Examples and Comparative Examples will be described below.

(1) Tensile Elongation and Flexural Modulus

Polyacetal resin composition pellets were injection-molded using EC-75NII molding machine manufactured by Toshiba Machine Co., Ltd. under injection molding conditions involving a cylinder temperature of 205° C. and a mold temperature of 120° C. to obtain a 4 mm thick ISO specimen. The tensile elongation (%) and the flexural modulus (MPa) were measured in accordance with I50527-1 and IS0178, respectively, using the obtained ISO specimen.

(2) Dispersion (standard deviation) of Charpy impact strength

Polyacetal resin composition pellets were injection-molded using EC-75NII molding machine manufactured by Toshiba Machine Co., Ltd. under injection molding conditions involving a cylinder temperature of 205° C. and a mold temperature of 120° C. to obtain a 4 mm thick ISO specimen. The Charpy impact strength (kJ/m²) was measured in accordance with IS0179 using the obtained ISO specimen. Ten samples were assayed for each specimen, and standard deviation was determined as an index for dispersion.

(3) Measurement of Void Occurrence Rate of Pellet

10 g of polyacetal resin composition pellets (diameter: 2 mm, cylindrical shape with a length of 5 mm) was randomly collected, and the number of pellets penetrated by formed voids was visually measured. The results were assessed as the void occurrence rate (%) on the basis of the following criteria according to the following expression (1).

Void occurrence rate (%)={Weight (g) of pellets penetrated by voids/10 (g)}×100 Expression (1)

A: 15% or less

B: More than 15% and less than 19%

C: 19% or more

(4) Torque Variation

When the polyacetal resin compositions of Examples and Comparative Examples were produced using a twin screw extruder, the torque variation of the extruder for 15 minutes was evaluated on the basis of the following criteria.

+++: The range of the torque variation is 0% or more and less than 3%.

++: The range of the torque variation is 3% or more and less than 4%.

+: The range of the torque variation is 4% or more.

(5) Moldability (Mold Deposit Resistance)

Polyacetal resin composition pellets were continuously molded according to molding conditions (a) given below. The mold deposit resistance in this operation was evaluated on the basis of criteria (b) given below.

(a) Molding Conditions Injection molding machine: Ti-30G manufactured by Toyo Machinery & Metal Co., Ltd.

Cylinder temperature: 200° C.

Mold temperature: 30° C.

Molding cycle: injection time/cooling time=5 seconds/4 seconds

Molded article size: 35 mm long, 15 mm wide, and 2 mm thick
With a degassing part at the tip of the flow end of the mold cavity

The number of molding shots: 1000 shots

### (b) Criteria for Evaluating Mold Deposit Resistance

The status of mold deposits (stains) within the mold cavity at the 1000th shot from the start of molding was observed on the basis of the following criteria:

5: Stains are present only in the degassing part, or stains are present in the range of 1/10 or less of the total area of the degassing part and the inside and the outside of the mold cavity.

4: Stains are present in the range of more than 1/10 and ⅛ or less of the total area of the degassing part and the inside and the outside of the mold cavity.

3: Stains are present in the range of more than ⅛ and ⅕ or less of the total area of the degassing part and the inside and the outside of the mold cavity.

2: Stains are present in the range of more than ⅕ and ⅓ or less of the total area of the degassing part and the inside and the outside of the mold cavity. 1: Stains are present in the range of more than ⅓ of the total area of the degassing part and the inside and the outside of the mold cavity.

<Polyacetal Resin (A)>

### (A-1) Polyacetal Resin

Polyacetal copolymer containing 100 mol % of trioxane and 1.5 mol % of 1,3-dioxolane as copolymerized components and having MFR (conditions: conforming to IS01133, 190° C., 2.16 kg load) of 10 g/10 min

<Fatty Acid Metal Salt (B)>

### (B-1) Calcium Stearate

### (B-2) Zinc Stearate

<Zinc Oxide (C)>

### (C-1) Zinc Oxide (Average Primary Particle Size: 0.53 μm)

### (C-2) Zinc Oxide (Average Primary Particle Size: 0.17 μm)

<(D) Other Components>

(D-1) Antioxidant: Triethylene glycol-bis[3-(3-t-butyl-5-methyl-4-hydroxyphenyl)-propionate] (Irganox 245)

### (D-2) Polyamide Resin: Polyamide 6-6 (Average Particle Size: 10 μm)

(D-3) Polyolefin: LDPE (MFR: 7 g/10 min)

### Production of Polyacetal Resin Composition

In the present Examples, the components (A) to (C) were supplied from a main extrusion throat through a constant mass feeder using a twin screw extruder (TEM-26SS manufactured by Toshiba Machine Co., Ltd.) with all cylinder temperatures set to 200° C. The kneaded resin product was extruded into a strand under conditions involving an extrusion output of 15 kg/hr and a screw speed of 150 rpm, then rapidly cooled in a strand bath, and cut with a strand cutter to obtain pellets. The obtained resin composition was evaluated for its physical properties. The evaluation results are described in Table 1.

TABLE 1

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4 | ple 5 | ple 6 | ple 7 | ple 8 | ple 9 |
| (A) Polyacetal resin | parts by mass | 100 | 100 | 100 | 100 | 100 | 100 | 100 | 100 | 100 |
| (B-1) Calcium stearate | parts by mass | 0.25 | 0.35 | 0.5 | 0.25 | | 0.23 | 0.24 | 0.35 | 0.35 |
| (B-2) Zinc stearate | parts by mass | | | | | 0.5 | | | | |
| (C-1) Zinc oxide | parts by mass | 0.7 | 0.7 | 0.7 | | 0.7 | 0.27 | 1.0 | 0.7 | 0.7 |
| (C-2) Zinc oxide | parts by mass | | | | 0.7 | | | | | |
| (D-1) Antioxidant | parts by mass | | | | | | | | 0.4 | 0.4 |
| (D-2) Polyamide resin | parts by mass | | | | | | | | | 0.03 |
| (B)/(C) mass ratio | − | 0.357 | 0.500 | 0.714 | 0.357 | 0.714 | 0.852 | 0.240 | 0.500 | 0.500 |
| Total content of | % by mass | 100 | 100 | 100 | 100 | 100 | 100 | 100 | 99.6 | 99.6 |
| components | | | | | | | | | | |
| (A), (B) and (C) | | | | | | | | | | |
| Tensile elongation | % | 40 | 37 | 37 | 30 | 40 | 41 | 39 | 37 | 38 |
| Flexural modulus | MPa | 2655 | 2614 | 2570 | 2639 | 2544 | 2640 | 2595 | 2610 | 2630 |
| Charpy standard deviation | − | 0.23 | 0.22 | 0.34 | 0.25 | 0.35 | 0.22 | 0.31 | 0.25 | 0.22 |
| Void | % | A | A | B | B | B | B | A | A | A |
| Torque variation | − | +++ | +++ | +++ | +++ | ++ | ++ | ++ | +++ | +++ |
| Moldability (mold deposit | − | 4 | 4 | 4 | 4 | 4 | 4 | 4 | 5 | 5 |
| resistance) | | | | | | | | | | |
| | | Com- | Com- | Com- | Com- | Com- | Com- | Com- | Com- | Com- |
| | | parative | parative | parative | parative | parative | parative | parative | parative | parative |
| | | Exam- | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 8 | ple 9 |
| (A) Polyacetal resin | parts by mass | 100 | 100 | 100 | 100 | 100 | 100 | 100 | 100 | 100 |
| (B-1) Calcium stearate | parts by mass | | 0.25 | 1.1 | 0.5 | 1.1 | 0.005 | 0.35 | 0.35 | 0.35 |
| (B-2) Zinc stearate | parts by mass | | | | | | | | | |
| (C-1) Zinc oxide | parts by mass | 0.7 | | 0.7 | 3.2 | 3.2 | 0.01 | 0.7 | 0.7 | 0.7 |
| (C-2) Zinc oxide | parts by mass | | | | | | | | | |
| (D-1) Antioxidant | parts by mass | | | | | | | 3.0 | | 0.5 |
| (D-3) Polyolefin | parts by mass | | | | | | | | 5.0 | 5.0 |
| (B)/(C) mass ratio | − | 0.000 | | 1.571 | 0.156 | 0.344 | 0.500 | 0.500 | 0.500 | 0.500 |
| Total content of | % by mass | 100 | 100 | 100 | 100 | 100 | 100 | 97.1 | 95.3 | 94.8 |
| components | | | | | | | | | | |
| (A), (B) and (C) | | | | | | | | | | |
| Tensile elongation | % | 31 | 43 | 25 | 24 | 25 | 39 | 36 | 40 | 42 |
| Flexural modulus | MPa | 2612 | 2612 | 2290 | 2655 | 2640 | 2620 | 2561 | 2465 | 2453 |
| Charpy standard deviation | − | 1.04 | 0.33 | 0.40 | 0.52 | 0.72 | 0.35 | 0.25 | 0.36 | 0.40 |
| Void | % | C | C | C | C | C | C | B | B | B |
| Torque variation | − | + | ++ | ++ | + | + | ++ | ++ | +++ | +++ |
| Moldability (mold deposit | − | 3 | 3 | 2 | 2 | 2 | 3 | 2 | 3 | 3 |
| resistance) | | | | | | | | | | |

### Examples 1 to 9 and Comparative Examples 1 to 9

The components were formulated at the ratio provided by Table 1, and melt-kneaded by the production method mentioned above. The obtained pellets were used to conduct evaluation by the method mentioned above. The measurement and evaluation results are described in Table 1.

### INDUSTRIAL APPLICABILITY

The polyacetal resin composition according to the disclosure can be used as a replacement for metals, particularly, for cost reduction or weight reduction, in various fields in which polyacetal resin compositions have been suitably used. Therefore, the polyacetal resin composition according to the disclosure has industrial applicability in fields such as automobiles, precision parts of electric or electronic equipment, and other industries.

1. A resin composition at least comprising 100 parts by mass of polyacetal resin (A), 0.01 to 1 part by mass of fatty acid metal salt (B), and 0.1 to 3 parts by mass of zinc oxide (C), wherein a total content of the polyacetal resin (A), the fatty acid metal salt (B), and the zinc oxide (C) is 98.0% by mass or more.

2. The resin composition according to claim 1, wherein a content ratio of the fatty acid metal salt (B) to the zinc oxide (C) is 0.053 to 1.000.

3. The resin composition according to claim 2, wherein a content ratio of the fatty acid metal salt (B) to the zinc oxide (C) is 0.250 to 0.667.

4. The resin composition according to claim 1, wherein the fatty acid metal salt (B) is at least one member selected from the group consisting of calcium stearate and zinc stearate.

5. The resin composition according to claim 1, wherein the zinc oxide (C) has an average primary particle size of 0.3 to 0.8 μm.

6. The resin composition according to claim 1, wherein a total amount of the fatty acid metal salt (B) and the zinc oxide (C) is 0.6 to 1.4 parts by mass per 100 parts by mass of polyacetal resin (A).

7. The resin composition according to claim 1, further comprising 0.1 to 0.4 parts by mass of a hindered phenol-based antioxidant per 100 parts by mass of the polyacetal resin (A).

8. The resin composition according to claim 7, further comprising 0.01 to 0.03 parts by mass of polyamide resin per 100 parts by mass of the polyacetal resin (A).

9. The resin composition according to claim 8, consisting of only the polyacetal resin (A), the fatty acid metal salt (B), the zinc oxide (C), the hindered phenol-based antioxidant, and the polyamide resin.

10. A molded article comprising a resin composition according to claim 1.

11. The resin composition according to claim 2, wherein the fatty acid metal salt (B) is at least one member selected from the group consisting of calcium stearate and zinc stearate.

12. The resin composition according to claim 2, wherein the zinc oxide (C) has an average primary particle size of 0.3 to 0.8 μm.

13. The resin composition according to claim 2, wherein a total amount of the fatty acid metal salt (B) and the zinc oxide (C) is 0.6 to 1.4 parts by mass per 100 parts by mass of polyacetal resin (A).

14. The resin composition according to claim 2, further comprising 0.1 to 0.4 parts by mass of a hindered phenol-based antioxidant per 100 parts by mass of the polyacetal resin (A).

15. A molded article comprising a resin composition according to claim 2.
